(19) United States
(12) Patent Application Publication
(10) Pub. No.: US 2013/0176414 A1
(43) Pub. Date: Jul. 11, 2013

(54) INTELLIGENT TRACKING DEVICE

(71) Applicants: CHIH-LYANG HWANG, Tu-Cheng (TW); CHIEN-CHUN FU, Tu-Cheng (TW)

(72) Inventors: CHIH-LYANG HWANG, Tu-Cheng (TW); CHIEN-CHUN FU, Tu-Cheng (TW)

(73) Assignee: HON HAI PRECISION INDUSTRY CO., LTD., Tu-Cheng (TW)

(21) Appl. No.: 13/420,582

(22) Filed: Mar. 14, 2012

(30) Foreign Application Priority Data
Jan. 6, 2012 (TW) 101100715

(51) Int. Cl. H04N 7/18; G01S 15/89

(52) U.S. Cl. 348/77; 348/E07.085

(57) ABSTRACT

An intelligent tracking device being carried by a support includes a camera unit, a sound detecting unit, a tracking control unit, a control unit, and a driving unit. The tracking control unit recognizes a human face and determines the position of the face. The control unit determines a movement of the recognized face according to the determined position and generates a control signal according to the determined movement of the recognized face. If no human face is recognizable in the view scope of the camera unit, the control unit activates the sound detecting unit, and the tracking control unit determines a direction and distance of a sound source relative to the intelligent tracking device according to the sound detected by the sound detecting unit, the driving unit drives the support to move according to the direction and distance.

### BACKGROUND

1. Technical Field

The present disclosure relates to an electronic device and, particularly, to an electronic device able to function as an intelligent tracking device.

2. Description of the Related Art

When taking pictures using a portable electronic apparatus, such as a mobile phone, shaking often occurs due to the smallness and lightness of the portable electronic apparatus. The shaking may result in bad quality pictures. Moreover, when the object in front of the electronic apparatus moves, the operator needs to manually adjust the camera to follow the movements of the object. Therefore, it is very inconvenient to utilize the electronic apparatus to take pictures.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an intelligent tracking device in accordance with an exemplary embodiment.

FIGS. 2-5 are isometric exploded views of the intelligent tracking device in FIG. 1.

FIG. 6 is a flowchart illustrating a tracking method applied in the intelligent tracking device of FIG. 1, in accordance with an exemplary embodiment.

### DETAILED DESCRIPTION

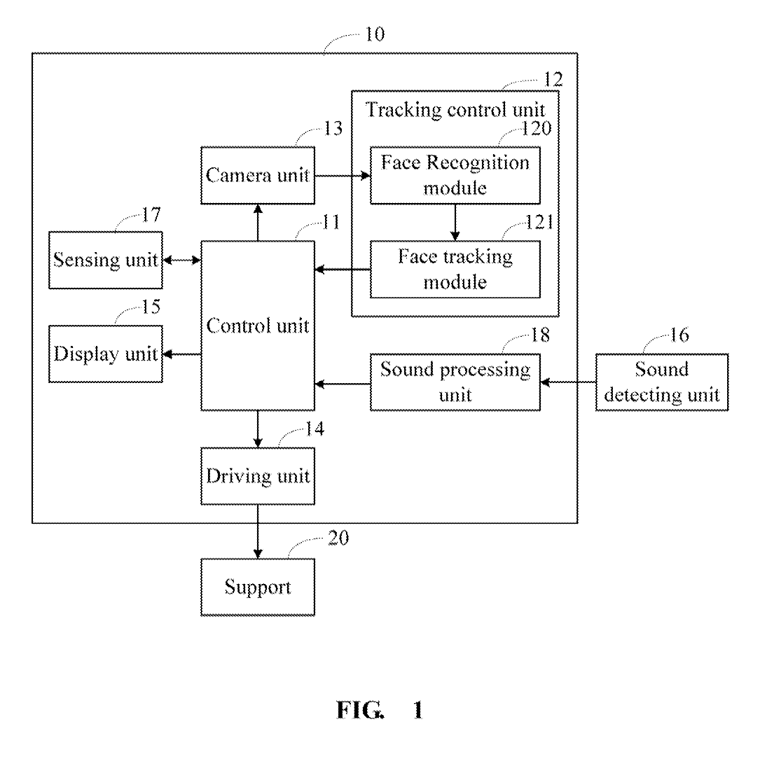

FIG. 1 is a block diagram of an intelligent tracking device in accordance with an exemplary embodiment. The intelligent tracking device 10 can be a tablet personal computer (PC), a personal digital assistant (PDA), or the like. The intelligent tracking device 10 includes a control unit 11, a tracking control unit 12, a camera unit 13, a driving unit 14, and a display unit 15. In the embodiment, the camera unit 13 is framed in the frame of the intelligent tracking device 10, and configured for taking pictures.

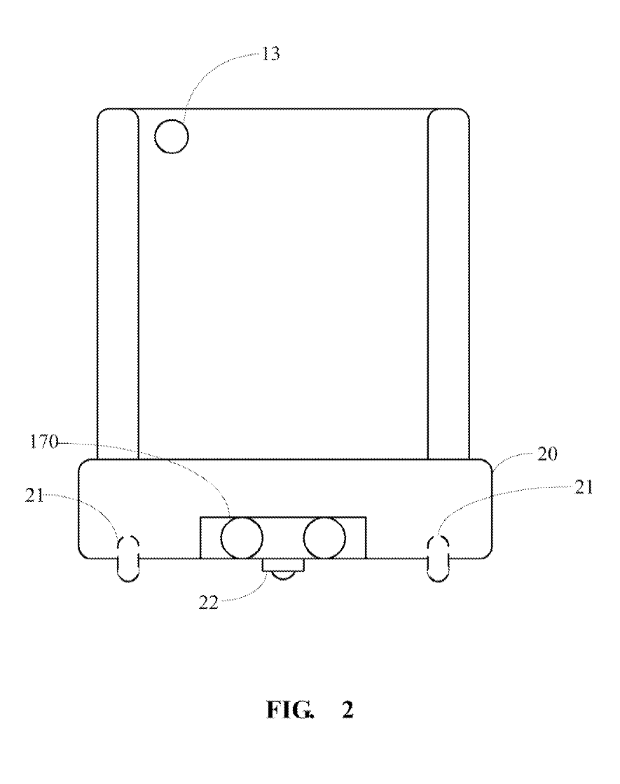

Referring to FIG. 2, a support 20 is configured for carrying the intelligent tracking device 10. The support 20 includes a motor (not shown) for driving a pair of wheels 21 mounted on the bottom of the support 20, and thus able to move the support 20. The intelligent tracking device 10 carried by the support 20 moves with the movements of the support 20. In the embodiment, the support 20 is also a charging cradle for providing power to the intelligent tracking device 10.

The tracking control unit 12 includes a face recognition module 120 and a face tracking module 121 connected to the recognition module 120. The face recognition module 120 is configured for recognizing a human faces in a view scope of the camera unit 13. The face tracking module 121 is configured to determine the position of the face in real time. The control unit 11 is configured to determine the apparent direction(s) and/or nature of any motion of the recognized face according to the positions of the face determined by the face tracking module 121, and generates a first control signal according to the determined movement of the recognized face to the driving unit 14. The driving unit 14 is configured to drive the support 20 to move synchronically with the movement of the recognized face in response to the first control signal, thereby the camera unit 13 can track the movement of the face. For example, the control unit determines the movement of a face according to a first position and a next position of the face.

The intelligent tracking device 10 further includes a sound detecting unit 16, the sound detecting unit 16 includes a number of microphones 160 also framed in the frame of the intelligent tracking device 10. The intelligent tracking device 10 further includes a sound signal processing module 122. In the embodiment, if the control unit 11 determines that an open or clear view of the human face is not recognizable in the view scope of the camera unit 13, the face tracking module 121 sends a recognition signal to the control unit 11 to activate the sound detecting unit 16. The sound signal processing module 122 is configured to determine the direction and distance of a sound source, such as people's speaking, relative to the intelligent tracking device 10 according to the detect sound. Then the control unit 11 sends a first control signal according to the determined direction and distance of the sound source to the driving unit 14, and the driving unit 14 drives the support 20 to move. In the embodiment, the control unit 11 determines an object is blocking the view if the camera unit 13 captures no human face when the support 20 rotates 360° or more.

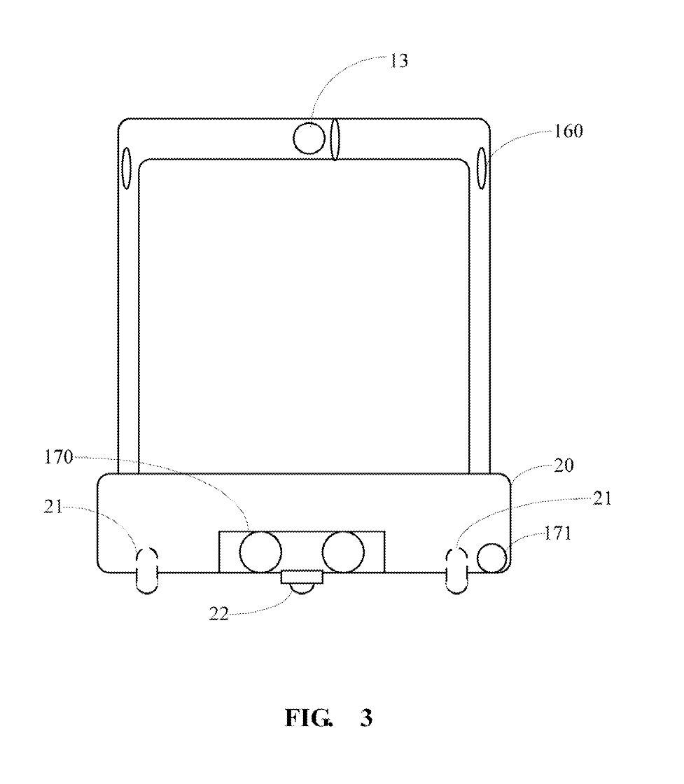

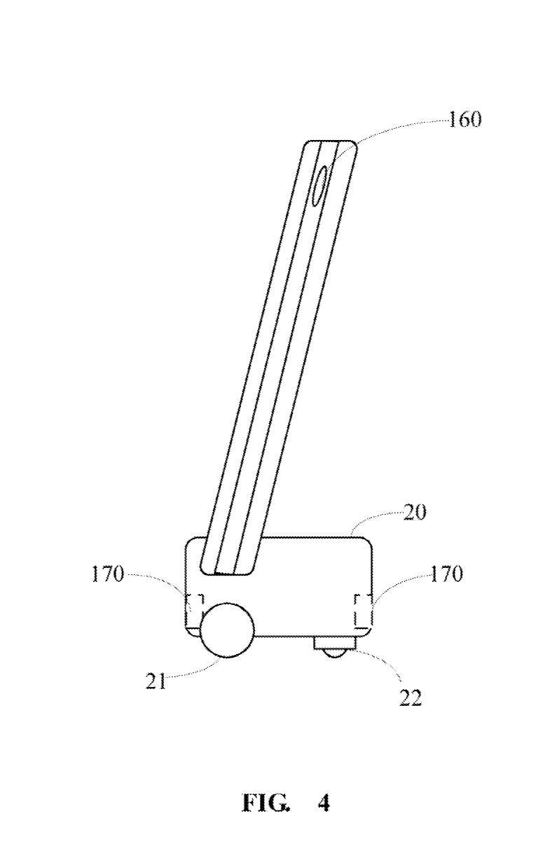

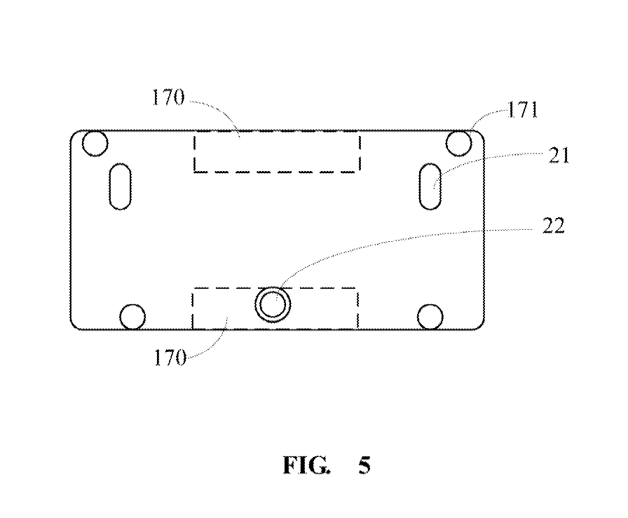

Referring to FIGS. 3-5, in the embodiment, the support 20 further includes a universal wheel 22 mounted on the bottom of the support 20. The pair of wheels 21 and the universal wheel 22 are configured to cooperatively support the support 20 and allow the support 20 to move. The intelligent tracking device 10 further includes a sensing unit 17, mounted on the surface of the intelligent tracking device 10, configured to sense whether there is an obstacle blocking a clear view around the intelligent tracking device 10. The control unit 11 generates a second control signal to the driving unit 14 to adjust the motion of the support 20 or stop the support 20 moving when the sensing unit 17 senses there is a blocking obstacle around the intelligent tracking device 10. In the embodiment, the sensing unit 17 includes an ultrasonic sensor 170 and an infrared sensor 171. When the infrared sensor 171 emits infrared light but does not receive any reflected infrared light (i.e., feedback infrared signal), the control unit 11 determines the support 20 has reached an edge of a plane where the support 20 stands. Also, the ultrasonic sensor 170 may emit ultrasonic waves to determine whether the support 20 has reached an edge of the plane by analyzing the reflected ultrasonic waves.

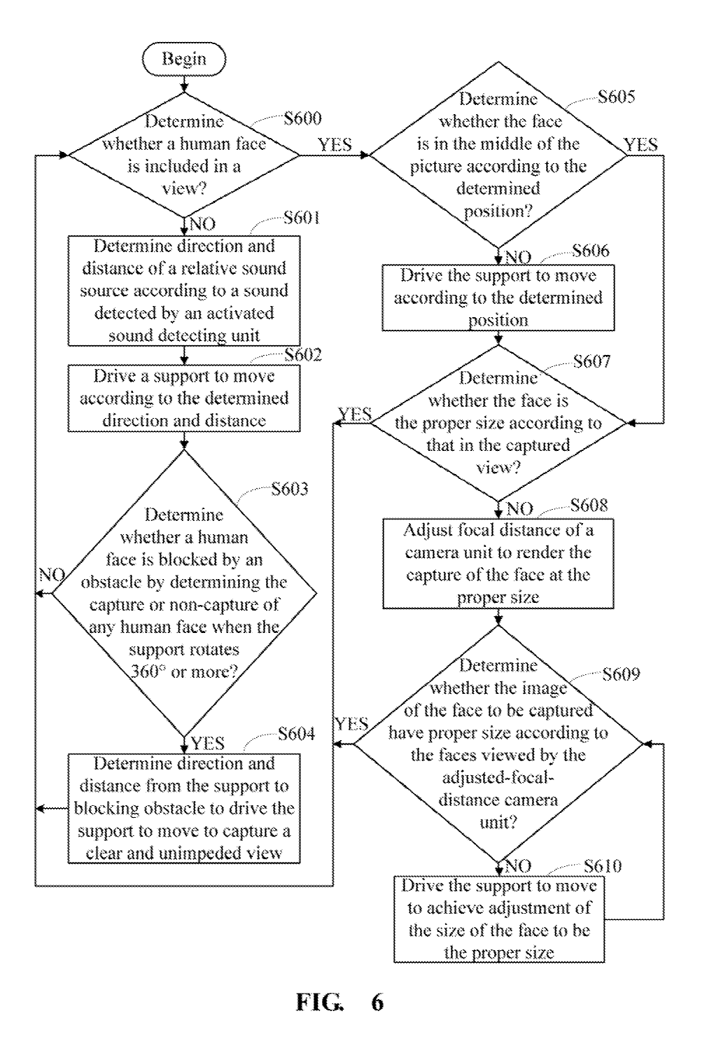

FIG. 6 is a flowchart illustrating a tracking method applied in the intelligent tracking device 10.

In step S600, the face recognition module 120 determines whether a human face is included in a view or scene in front of the camera unit 13. If no human face is included, the procedure goes to step S601, otherwise, the procedure goes to step S605.

In step S601, the face tracking module sends a recognition signal to the control unit 11 to activate the sound detecting unit 16, the sound signal processing module 122 determines the direction and distance of the sound source, such as people's speaking, relative to the intelligent tracking device 10 according to the sound signal received by the sound detecting unit 16.

In step S602, the control unit 11 sends the first control signal according to the determined direction and distance of the sound source to the driving unit 14 to the driving unit 14, the driving unit 14 drives the support 20 to move.

In step S603, the control unit 11 determines whether a human face is blocked by an obstacle by determining the capture or non-capture of any human face by the camera unit 13 when the support 20 rotates 360° or more. If yes, the procedure goes to step S604, otherwise, the procedure ends.

In step S604, the control unit 11 determines the direction and distance from the support 20 of any blocking obstacle, to generate the second control signal to the driving unit 14. The driving unit 14 drives the support 20 to move in response to the second control signal, thereby facilitating, or tending towards, the capture of a clear and unimpeded view by the camera unit 13.

In the embodiment, the intelligent tracking device 10 further includes a sensing unit 17, mounted on the surface of the intelligent tracking device 10, configured to sense whether there is an obstacle around the intelligent tracking device 10 which impedes a clear and open view of a desired scene. The control unit 11 generates the second control signal to the driving unit 14 to adjust the direction of the support 20, or stop the support 20 moving, when the sensing unit 17 senses any blocking obstacle around the intelligent tracking device 10. In the embodiment, the sensing unit 17 includes an ultrasonic sensor 170 and an infrared sensor 171. When the infrared sensor 171 emits infrared signals but does not receive any reflected infrared signal (i.e., feedback infrared signal), the control unit 11 determines that the support 20 has reached a point of view which is not impeded by an blocking obstacle. Also, the ultrasonic sensor 170 can emit ultrasonic signals to make a similar determination, by determining the reception or otherwise of reflected ultrasonic signals.

In step S605, the face tracking module 121 determines the position(s) of the face(s) in real time, the control unit 11 determines whether the face(s) is in the middle of the picture according to the determined position, if yes, the procedure goes to step S607, otherwise, the procedure goes to step S606.

In step S606, the control unit 11 generates a signal to the driving unit 14 according to the determined position of the face(s), and the driving unit 14 drives the support 20 to move in response to the signal, then the procedure returns to step S605.

In step S607, the control unit 11 determines whether the face(s) is the proper size according to the face(s) in the view captured by the camera unit 13, if yes, the procedure ends, otherwise, the procedure goes to step S608.

In step S608, the control unit 11 controls the camera unit 13 to adjust focal distance to render the capture of the face(s) at the proper size.

In step S609, the face recognition module 120 recognizes that human faces are being viewed by the adjusted-focal-distance camera unit 13, and the control unit 11 determines whether the image of the face(s) to be captured have proper size according to the faces in the view recognized by the face recognition module 120, if yes, the procedure ends, otherwise, the procedure goes to step S610.

In step S610, the control unit 11 generates a signal to the driving unit 14, the driving unit 14 drives the support 20 to move to achieve adjustment of the size of the face(s) to be the proper size, then the procedure goes to step S609.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An intelligent tracking device, the intelligent tracking device configured for being carried by a support, the intelligent tracking device comprising:
a camera unit;
a tracking control unit configured for recognizing a human face in a view scope of the camera unit, and determining the position of the face in real time;
a control unit configured for determining a movement of the recognized face according to the determined positions of the face, and generating a first control signal according to the determined movement of the recognized face;
a driving unit configured for driving the support to move synchronically with the movement of the recognized face in response to the first control signal; and
a sound detecting unit configured for detecting sound from a sound source, the tracking control unit configured for activating the sound detecting unit if no human face is recognizable in the view scope of the camera unit, the tracking control unit configured for determining a direction and distance of a sound source relative to the intelligent tracking device according to the detect sound, the driving unit configured for driving the support to move according to the determined direction and distance of the sound source.

2. The intelligent tracking device as recited in claim 1, further comprising a frame, wherein the camera unit is mounted in the frame.

3. The intelligent tracking device as recited in claim 1, further comprising a frame, wherein the sound detecting unit comprises a plurality of microphones mounted in the frame.

4. The intelligent tracking device as recited in claim 1, further comprising a sensing unit configured for sensing whether there is an obstacle blocking the recognized face, the control unit generates a second control signal to the driving unit to adjust the motion of the support if the sensing unit senses there is a blocking obstacle.

5. The intelligent tracking device as recited in claim 4, wherein the sensing unit comprises an ultrasonic sensor for emitting ultrasonic waves to determine whether the support has reached an edge of a plane where the support stands by analyzing the reflected ultrasonic waves.

6. The intelligent tracking device as recited in claim 4, wherein the sensing unit comprises an infrared sensor for emitting infrared light to determine whether the support has reached an edge of a plane where the support stands by analyzing reflected infrared light.
